(19) United States
(12) Patent Application Publication
(10) Pub. No.: US 2025/0004739 A1
(43) Pub. Date: Jan. 2, 2025

(54) PROGRAM INSTALLATION METHOD AND DEVICE THEREOF, STORAGE MEDIUM, AND COMPUTER DEVICE

(71) Applicant: Zhuhai Pantum Electronics Co., Ltd., Zhuhai (CN)

(72) Inventors: Yao LU, Zhuhai (CN); Yunying SHANG, Zhuhai (CN); Tao HOU, Zhuhai (CN); Qiang ZHANG, Zhuhai (CN)

(21) Appl. No.: 18/755,827

(22) Filed: Jun. 27, 2024

(30) Foreign Application Priority Data
Jun. 29, 2023 (CN) 202310788318.X

(51) Int. Cl. G06F 8/61

(52) U.S. Cl. CPC G06F 8/61; G06F 8/62

(57) ABSTRACT

A program installation method and device, a storage medium, and a computer device are provided. The program installation method is executed after installing a driver program corresponding to a peripheral device through a first method. The first method includes automatically downloading a driver package and automatically installing the driver program in response to a connection signal of the peripheral device. The program installation method includes: installing an extension program in the driver package; and creating a shortcut of the extension program in a user interaction interface according to a device information file.

### CROSS-REFERENCE TO RELATED APPLICATION

This application claims the priority of Chinese Patent Application No. 202310788318.X, filed on Jun. 29, 2023, the content of which is incorporated herein by reference in its entirety.

### TECHNICAL FIELD

The present disclosure generally relates to the field of computer technology and, more particularly, relates to a program installation method and device, a storage medium, and a computer device.

### BACKGROUND

Some operating systems allow device manufacturers to upload driver programs to operating system providers' servers in advance. When an operating system of a computer device detects a connection signal indicating that a peripheral device is connected, the operating system queries a driver program corresponding to the peripheral device in a server, and then download the driver program corresponding to the peripheral device to the computer device and automatically perform the installation.

Some peripheral devices such as image forming devices have some extension functions in addition to necessary functions supported by driver programs. However, extension programs corresponding to the extension functions require users to install them manually, which is inconvenient for users to use. On the other hand, even when the extension programs are installed through automatic installation, since the installation automatically performed by the operating system is sometimes a silent installation, the user may not know which extension programs have been installed after the operating system has connected the peripheral device, and cannot determine whether the installation is complete. Therefore, the users have difficulty using functions of the peripheral devices corresponding to the extension programs, thereby reducing the convenience of use.

### SUMMARY

One aspect of the present disclosure provides a program installation method. The program installation method is executed after installing a driver program corresponding to a peripheral device through a first method. The first method includes automatically downloading a driver package and automatically installing the driver program in response to a connection signal of the peripheral device. The program installation method includes: installing an extension program in the driver package; and creating a shortcut of the extension program in a user interaction interface according to a device information file.

Another aspect of the present disclosure provides a program installation device. The device includes: a detection module, configured to detect a connection signal of a peripheral device; a download module, configured to automatically download a driver package in response to the connection signal; an installation module, configured to install a driver program and an extension program in the driver package; and a first creation module, configured to create a shortcut of the extension program in a user interaction interface according to a device information file after installing the extension program in the driver package.

Another aspect of the present disclosure provides a non-transitory computer-readable storage medium containing a program that, when being executed, causes a device where the storage medium is located to perform a program installation method. The program installation method is executed after installing a driver program corresponding to a peripheral device through a first method. The first method includes automatically downloading a driver package and automatically installing the driver program in response to a connection signal of the peripheral device. The program installation method includes: installing an extension program in the driver package; and creating a shortcut of the extension program in a user interaction interface according to a device information file.

Another aspect of the present disclosure provides a computer device including a memory and a processor. The memory is configured to store information including program instructions; and the processor is configured to control execution of the program instructions. When the program instructions are loaded and executed by the processor, the computer device performs a program installation method. The program installation method is executed after installing a driver program corresponding to a peripheral device through a first method. The first method includes automatically downloading a driver package and automatically installing the driver program in response to a connection signal of the peripheral device. The program installation method includes: installing an extension program in the driver package; and creating a shortcut of the extension program in a user interaction interface according to a device information file.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flowchart of an exemplary program installing method according to various disclosed embodiments of the present disclosure.

FIG. 2 illustrates a structure of an exemplary program installing system according to various disclosed embodiments of the present disclosure.

FIG. 3 illustrates a structure of another exemplary program installing system according to various disclosed embodiments of the present disclosure.

FIG. 4 illustrates an exemplary driver package according to various disclosed embodiments of the present disclosure.

FIG. 5 illustrates a schematic diagram of creating a shortcut of an extension program in a user interaction interface based on device information files, according to various disclosed embodiments of the present disclosure.

FIG. 6 illustrates an exemplary program installing device according to various disclosed embodiments of the present disclosure.

FIG. 7 illustrates an exemplary computer device according to various disclosed embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. The embodiments disclosed herein are exemplary only. Other applications, advantages, alternations, modifications, or equivalents to the disclosed embodiments are obvious to those skilled in the art and are intended to be encompassed within the scope of the present disclosure.

It should be noted that the terms used in the embodiments of the present disclosure are only for the purpose of describing specific embodiments, and are not intended to limit the scope of the present disclosure. As used in the embodiments of the present disclosure and the appended claims, the singular forms such as “a”, “said” and “the” are also intended to include the plural forms unless the context clearly indicates otherwise.

It should be understood that the term “and/or” used in this specification is just for relationship description of related objects, indicating that there can be three kinds of relationships. For example, A and/or B, which can mean that A exists alone, A and B exist at the same time, and B exists alone. In addition, the character “/” in this specification generally indicates that the related objects are in an “or” relationship.

A common driver program installation method in existing technologies is optical disc installation. A user inserts an optical disc into an optical disc driver of a computer device, and the computer device reads a driver program stored in the optical disc to implement installation. However, many computer devices are no longer equipped with optical drivers. When the optical disc installation method is still used, the user needs to configure an additional external optical driver, which is not easy to use and has low convenience.

Another driver program installation method includes storing a driver program in a memory inside an image forming device. When the user uses a communication cable such as a universal serial bus (USB) cable to connect the image forming device and a computer device, the computer device recognizes the image forming device as a storage device, reads the driver program from the image forming device to install the driver program. However, the driver program will occupy an internal storage space of the image forming device and increase production costs.

In another driver program installation method, the user downloads the driver program from the device manufacturer's homepage and manually installs the driver program when connected to the network. The user operation is cumbersome, and the convenience is low.

The above driver program installation methods have the following problems.
1. Only the driver program is installed. But for image forming devices such as printers or scanners, there are some corresponding extension programs such as status monitors or push-scan tools, which enable the image forming device to implement more types of functions. These extension programs will not be installed along with the driver program, and the user still needs to install these extension programs manually, resulting in insufficient convenience.
2. The installation method is silent installation in the background. After the driver program installation is completed, the user may still not know that the driver program has been installed on the computer device, which may cause the user to repeat the installation.
3. After the installation is completed, no shortcut will be created. When the user wants to open the driver program to set parameters or select functions, the user needs to search for the driver program in the installation directory, which makes the operation less convenient.

The latest Windows® systems, such as Windows 10® or Windows 11®, etc., from Microsoft®, already support driver-free installation of driver programs. Most driver-free installations are performed through plug-and-play (PNP) installation. Taking a scan driver program as an example, after the user installs the scan driver program, the user is able to use the basic scanning function for saving the scanned image inside the image forming device. If the user wants to push the scanned image to an external computer connected to the image forming device, the user also needs to install a push-scan tool on the external computer to use the push-scan function. This push-scan tool is an example of an extension program. It can be seen that the push-scan tool is not a necessary program to use the basic functions of the image forming device, and therefore is not considered as the driver program and is not automatically installed in a plug-and-play manner. This makes the extension program difficult to install and use via driver-free installation. Further, when the user wants to uninstall the driver programs and extension programs from the computer at once, sometimes the uninstallation method provided by the operating system cannot successfully clear all files and registration information, and the legacy files or legacy registration information which are not deleted successfully will prevent the user from installing other driver programs on the computer and will unduly occupy the storage space of the user's computer.

The present disclosure provides a program installation method, to at least partially alleviate the above problems. FIG. 1 shows a flow chart of a program installation method provided by one embodiment of the present disclosure. As shown in FIG. 1, in one embodiment, the method may include:

S100: installing an extension program in a driver package; and

S102: creating a shortcut of the extension program in a user interaction interface according to a device information file.

In one embodiment, the method may be executed by a computer device. For example, the computer device may include a computer, a tablet, or a cell phone.

In one embodiment, before S100, the method may further include: receiving a connection signal of a peripheral device sent by an image forming device. The connection signal may include identification information of the image forming device. When the identification information is a preset supported model, a name of the image forming device may be obtained and a driver program corresponding to the identification information may be installed through a first method. The first method may include automatically downloading the driver package and automatically installing the driver program in response to the connection signal from the peripheral device. The connection signal may include a USB connection signal; or a local area network connection signal.

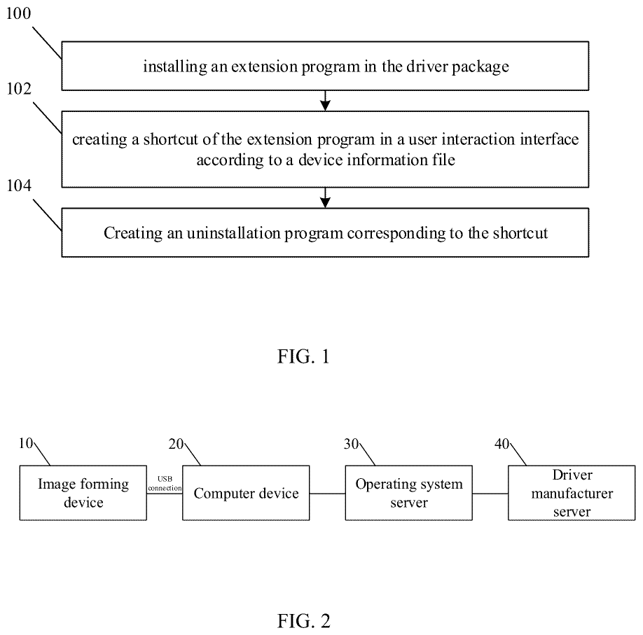

FIG. 2 is a schematic structural diagram of a program installation system provided by an embodiment of the present disclosure. As shown in FIG. 2, the image forming device 10 may be connected to the computer device 20 through USB, and the computer device 20 may be connected to an operating system server 30. The operating system server 30 may be connected to a driver manufacturer server 40. Based on the driver program installation system in FIG. 2, the driver manufacturer server 40 may send the driver program of the image forming device 10 to the operating system server 30 in advance. The operating system server 30 may store the driver program of the image forming device 10. The user may connect the image forming device 10 to the computer device 20 via USB. Correspondingly, the computer device 20 may receive the identification information of the image forming device 10. The computer device 20 may query the driver program corresponding to the identification information from the operating system server 30 based on the identification information. The computer device 20 then may install the driver program.

After the user connects the image forming apparatus 10 to the computer device 20 via a USB cable, the driver program may be installed automatically without user intervention.

In the present disclosure, the image forming device may include, but is not limited to, printers, copiers, fax machines, scanners, or multifunctional all-in-one machines that integrate printing, copying, faxing, scanning and other functions. Their function may be to print images or text on imaging media.

In one embodiment, when the operating system is Microsoft® Windows®, the operating system server 30 may send the driver program to the computer device 20 through the Windows® Hardware Equipment Quality Lab (Microsoft Windows Hardware Quality Lab, referred to as WHQL) testing. The driver manufacturer server 40 may send the driver program to the operating system server 30 through WHQL testing.

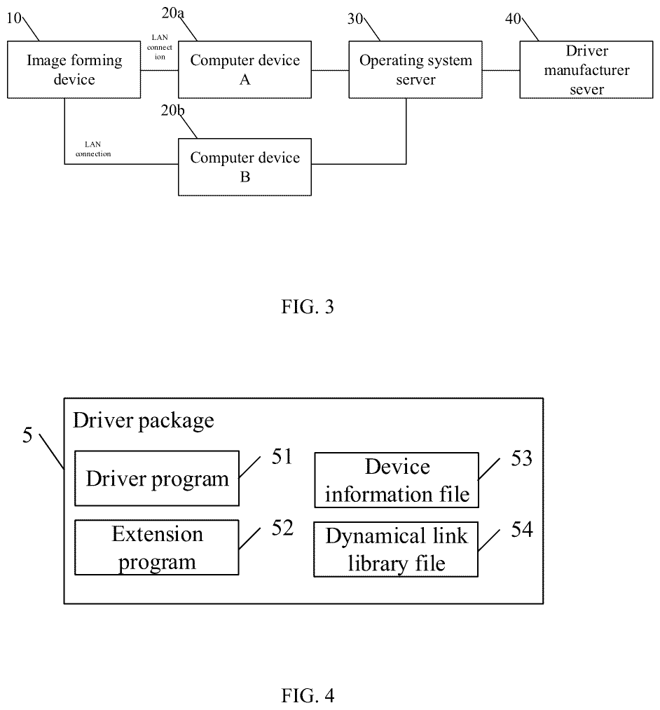

In another embodiment shown in FIG. 3 which is a structure of another program installation system, the image forming device 10 may be connected to the computer device A 20a through the local area network. The computer device A 20a may be connected to the operating system server 30 and the operating system server 30 may be connected to the driver manufacturer server 40. The image forming device 10 may be connected to the computer device B 20b through the local area network, the computer device 20b may be connected to the operating system server 30, and the operating system server 30 may be connected to the driver manufacturer server 40.

The user may already connect the image forming device 10 to the local area network through the computer device A 20a (for example, after connecting the image forming device 10 to the computer device A 20a via USB, the image forming device 10 may be connected to the local area network through network configuration software). When the user wants to use the image forming device 10 through the computer device B 20b, the computer device B 20b may connect the local area network, add a network printer through the control panel, and download the driver program from the operating system server 30. Then the computer device B 20b may install the driver program.

In one embodiment, as shown in FIG. 4, the driver package 5 may include: a driver program 51, an extension program 52, a device information file (INF) 53, and a dynamic link library (DLL) file 54.

In one embodiment, the user interaction interface may be displayed on a computer device or an image forming device.

In one embodiment, the shortcut may include a shortcut on a desktop of the operating system and/or a shortcut on a start menu of the operating system.

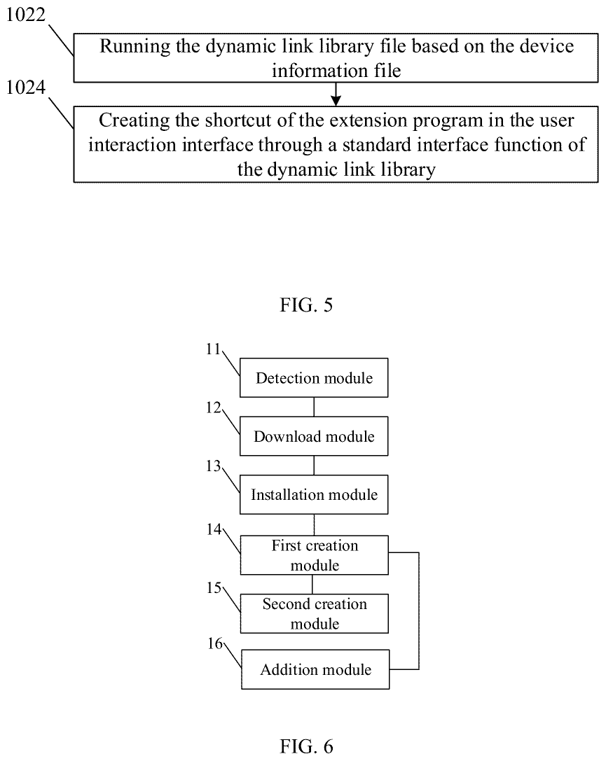

FIG. 5 shows a flowchart for creating the shortcut of the extension program on the user interaction interface according to the device information file. As shown in FIG. 5, in one embodiment, S102 may include:

S1022: executing the dynamic link library file according to the device information file; and

S1024: creating the shortcut of the extension program on the user interaction interface through a standard interface function in the dynamic link library file.

In one embodiment, the device information file may be associated with the dynamic link library file of the registered device corresponding to the extension program, and the dynamic link library file may be associated with the standard interface function. The standard interface function may be configured to create the shortcut for the extension program on the user interaction interface through the application programming interface. In one embodiment, the DLL file of the registered device corresponding to the driver program and extension program may be added under the keyword RegisterDlls of the INF. The DLL file may include the standard interface function DllRegisterServe. The standard interface function DllRegisterServe may create shortcuts by calling application programming interface (API).

For example, in one embodiment, when the driver program includes a scan program and the extension program includes a push-scan program, shortcuts created for the driver program and the extension program may include a shortcut for the push-scan program located in the Start menu and a shortcut for the scan program located in the Start menu, a shortcut for the scan program located on the desktop, a shortcut for scan uninstall program located in the Start menu, etc. When there are other extension programs, the other extension programs may continue to be added, to facilitate the user to use the scanning function of the image forming device.

In one embodiment, the DLL files and application (EXE) files of registered devices corresponding to drivers and extensions may be added under the keyword CopyFiles of INF, and the operating system may directly copy the above files to the usage directory. For example, the usage directory may be c: \windows\twain_32.

In one embodiment, the operating system of the computer device may use INF to configure the installation information. When the operating system recognizes that the image forming device is connected, the operating system may download the driver package containing the INF from the operating system server. When the driver package is executed, the operating system may copy the driver and extension program to the specified storage location according to the file copy keyword (CopyFiles) in INF. After the driver and extension program are copied to the specified storage location, according to the registration keyword (RegisterDlls) of INF, the standard interface function (DllRegisterServe) may be used to create shortcuts corresponding to the driver and the extension program. Therefore, after copying the driver and the extension program through CopyFiles, an additional shortcut that may be linked to the copied driver and extension program may be created. The operation of copying files through the CopyFiles keyword may not be prompted to the user, and sometimes the user may not know which extension functions have been installed, which leads to low usage of some functions that are able to improve the user experience. In this embodiment, after using the CopyFiles keyword to copy the extension program, the shortcut may be created for the extension program. Therefore, the possibility that the user does not know or forget the extension function installed through the Copyfile keyword resulting low usage of the extension function may be reduced, thereby improving the user experience.

In one embodiment, dynamic link library files and application files corresponding to the status monitor, network configuration software and uninstall software may be added to the device information file.

In the present embodiment, by adding the dynamic link library files and application files corresponding to the status monitor, network configuration software and uninstall software, the function expansion of driver-free installation may be realized, effectively improving the practicality of the driver under driver-free installation. Some additional small programs such as status monitors, network configuration software, or others may be provided, to facilitate users to use the image forming device.

In one embodiment, by adding the status monitor, when an abnormal state of the image forming device occurs, the abnormal state may be reported to the user in time. The user may be able to know the status of the image forming device on the computer device, which improves the user experience.

In one embodiment, under the INF keyword CopyFiles, added files related to the status monitor, network configuration software and uninstall software may include DLL and EXE files. The operating system may directly copy these related files to the corresponding implementation directory. For example, the implementation directory may be C: \Windows\System32.

In one embodiment, the method may further include S104.

In S104, an uninstallation program corresponding to the shortcut may be created.

In one embodiment, the DLL files and EXE files of the registered devices corresponding to the driver and extension programs may be added under the keyword DelFiles of the INF. The operating system may execute the uninstallation program corresponding to the driver program and extension programs, to delete these files from the usage directory.

In one embodiment, the driver program and the extension program may be installed in the computer device. When the uninstallation program corresponding to the driver program and the extension program is executed and the driver program and the extension program are not in use, the driver package, the shortcut and registry corresponding to the driver program, and the shortcut and registry corresponding to the extension program may be deleted, to delete all files and registries required for the driver program and extension program installation to prevent file residues from affecting the version upgrade of the driver program and extension program.

In the present disclosure, the installation method may be executed after installing the driver program corresponding to the peripheral device through the first method. The first method may include automatically downloading the driver package and automatically installing the driver program in response to the connection signal of the peripheral device. The installation method may include: after installing the extension program in the driver package, creating the shortcut of the extension program in the user interaction interface according to the device information file. In the present disclosure, after installing the extension program in the driver package, the shortcut to the extension program may be automatically created, which facilitates the user's use and improves the user's convenience in using the image forming device.

In the present disclosure, by adding the dynamic link library file to the driver package, the shortcut for the extension program may be created after one-click installation of the driver program and extension program, and the uninstaller program for uninstalling the shortcut may be also created. Therefore, it may be easier for users to use the image forming device and uninstall the drive program and extension program, enabling the function expansion of driver-free installation.

The present disclosure also provides a program installation device. As shown in FIG. 6 which is a structure of an exemplary program installation device, in one embodiment, the program installation device may include a determination module 11, a download module 12, an installation module 13, and a first creation module 14.

The detection module 11 may be used to detect a connection signal of a peripheral device. The download module 12 may be configured to automatically download a driver installation package in response to the connection signal. The installation module 13 may be used to install a driver program and an extension program in the driver package. The first creation module 14 may be configured to create a shortcut of the extension program on the user interaction interface based on the device information file after installing the extension program in the driver package.

In one embodiment of the present disclosure, the device may further include a second creation module 15.

The second creation module 15 may be used to create an uninstaller program corresponding to the shortcut.

In one embodiment of the present disclosure, the driver package may include: the driver program, the extension program, the device information file and the dynamic link library file.

In one embodiment of the present disclosure, when the uninstallation program corresponding to the driver and the extension program is executed and the driver program and the extension program are not in use, the driver package, the shortcut and registry corresponding to the driver program, and the shortcut and registry corresponding to the extension program may be deleted. Registry.

In one embodiment of the present disclosure, the first creation module 14 may be further used to add a dynamic link library file of the registered device corresponding to the extension program in the device information file. The dynamic link library file may include a standard interface function. In the standard interface function, the application program interface may be used to create the shortcut of the extension program in the user interaction interface.

In one embodiment, the device may further include an addition module 16.

The addition module 16 may be used to add dynamic link library files and application program files corresponding to the status monitor, network configuration software or uninstall software in the device information file.

In one embodiment, the connection signal may include a connection signal of a universal serial bus; or a connection signal of a local area network.

In the present disclosure, the installation method may be executed after installing the driver program corresponding to the peripheral device through the first method. The first method may include automatically downloading the driver package and automatically installing the driver program in response to the connection signal of the peripheral device. The installation method may include: after installing the extension program in the driver package, creating the shortcut of the extension program in the user interaction interface according to the device information file. In the present disclosure, after installing the extension program in the driver package, the shortcut to the extension program may be automatically created, which facilitates the user's use and improves the user's convenience in using the image forming device.

For the details of the program installation device, the reference may be made to the above embodiments of the program installation method.

The present disclosure also provides a storage medium. The storage medium may include a stored program. When the program is running, a device where the storage medium is located may be controlled to execute a program installation method provided by various embodiments of the present disclosure. For detailed description, the reference may be made to the above embodiments of the program installation method.

The present disclosure also provides a computer device. The computer device may include a memory and a processor. The memory may be configured to store information including program instructions. The processor may be configured to control the execution of program instructions. When the program instructions are loaded and executed by the processor, a program installation method provided by various embodiments of the present disclosure may be implemented. For detailed description, the reference may be made to the above embodiments of the program installation method.

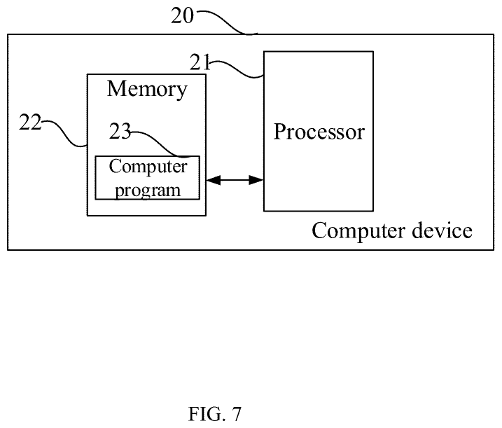

FIG. 7 illustrates a structure of a computer device provided by one embodiment of the present disclosure. As shown in FIG. 7, in one embodiment, the computer device 20 may include a processor 21, a memory 22, and a computer program 23 stored in the memory 22 which is able to run on the processor 21. When the program is loaded and executed by the processor 21, a program installation method provided by various embodiments of the present disclosure may be implemented. For detailed description, the reference may be made to the above embodiments of the program installation method. Or, when the program is loaded and executed by the processor 21, functions of modules or units of a program installation device provided by various embodiments of the present disclosure may be implemented.

In various embodiments, the computer device 20 may include, but is not limited to to, the processor 21 and the memory 22. The embodiment shown in FIG. 7 is only used as an example to illustrate the present disclosure only, and does not limit the scope of the present disclosure. In various embodiments, the computer device 20 may include more or less components, or different components, or combined components. For example, in one embodiment, the computer device may further include input/output devices, network connection devices, or buses.

The processor 21 may be a central processing unit (CPU), a general-purpose processor, a digital signal processor (DSP), an application specific integrated circuit (ASIC), a field-programmable gate array (FPGA) or other programmable logic devices discrete gate or transistor logic devices, discrete hardware components, etc. A general-purpose processor may be a microprocessor or the processor may be any conventional processor, etc.

The memory 22 may be an internal storage unit of the computer device 20, such as a hard disk or memory of the computer device 20. The memory 22 may also be an external storage device of the computer device 20, such as a plug-in hard disk, a smart memory card (Smart Media Card, SMC), a secure digital (SD) card, or a flash card equipped on the computer device 20. Further, the memory 22 may also include both an internal storage unit of the computer device 20 and an external storage device. The memory 22 may be used to store computer programs and other programs and data required by the computer device. The memory 22 may also be used to temporarily store data that has been output or is to be output.

The embodiments disclosed herein are exemplary only. Other applications, advantages, alternations, modifications, or equivalents to the disclosed embodiments are obvious to those skilled in the art and are intended to be encompassed within the scope of the present disclosure. In some cases, the actions or steps recited in the present disclosure may be performed in an order different from that in the embodiments and still achieve desirable results. In addition, the processes depicted in the accompanying figures do not necessarily require the particular order shown, or sequential order, to achieve desirable results. Multitasking and parallel processing may be also possible or may be advantageous in certain embodiments.

Any process or method descriptions in flowcharts or otherwise described herein may be understood to represent modules, segments or portions of code comprising one or more executable instructions for implementing custom logical functions or steps of a process, and the scope of preferred embodiments of this specification includes alternative implementations in which functions may be performed out of the order shown or discussed, including in substantially simultaneous fashion or in reverse order depending on the functions involved.

In the present disclosure, the disclosed systems, devices or methods can be implemented in other ways. For example, the device embodiments described above are only illustrative. For example, the division of the units is only a logical function division. In actual implementation, there may be other division methods. For example, multiple units or components may be combined or may be integrated into another system, or some features may be ignored or not implemented. In another point, the mutual coupling or direct coupling or communication connection shown or discussed may be through some interfaces, and the indirect coupling or communication connection of devices or units may be in electrical, mechanical or other forms. Each functional unit in each embodiment of the present disclosure may be integrated into one processing unit, or each unit may exist separately physically, or two or more units may be integrated into one unit. The above-mentioned integrated units can be implemented in the form of hardware, or in the form of hardware plus software functional units.

The integrated units implemented in the form of software functional units may be stored in a non-transitory computer-readable storage medium. The above-mentioned software functional units may be stored in a storage medium, including several instructions to enable a computer device (which may be a personal computer, a connector, or a network device, etc.) or a processor to execute a portion of the methods described in each embodiment of the present disclosure. The aforementioned storage media may include medium that can store program code such as a flash disk, a mobile hard disk, read-only memory (ROM), random access memory (RAM), magnetic disk or optical disc, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A program installation method executed after installing a driver program corresponding to a peripheral device through a first method, the first method including automatically downloading a driver package and automatically installing the driver program in response to a connection signal of the peripheral device, the program installation method comprising:
installing an extension program in the driver package; and
creating a shortcut of the extension program in a user interaction interface according to a device information file.

2. The method according to claim 1, after creating the shortcut of the extension program in the user interaction interface according to the device information file, further including:
creating an uninstallation program corresponding to the shortcut.

3. The method according to claim 1, wherein:
the driver package includes the driver program, the extension program, the device information file, and a dynamic link library file.

4. The method according to claim 3, wherein:
when the uninstallation program corresponding to the driver program and the extension program is executed and the driver program and the extension program are not in use, the driver package, a shortcut and a registry corresponding to the driver program, and the shortcut and registry corresponding to the extension program are deleted.

5. The method according to claim 3, wherein:
creating the shortcut of the extension program in the user interaction interface according to the device information file includes:
running the dynamic link library file based on the device information file; and
creating the shortcut of the extension program in the user interaction interface through a standard interface function of the dynamic link library,
wherein:
the device information file is associated with the dynamic link library file of a registered device corresponding to the extension program; and
the dynamic link library file is associated with the standard interface function; and
the standard interface function is configured to create the shortcut of the extension in the user interaction interface through an application programming interface.

6. The method according to claim 3, before creating the shortcut of the extension program in the user interaction interface according to the device information file, further including
adding dynamic link library files and application files corresponding to a status monitor, a network configuration software, or an uninstallation software to the device information file.

7. The method according to claim 1, wherein:
the connection signal includes a universal serial bus connection signal or a local area network connection signal.

8. A non-transitory computer-readable storage medium containing a program that, when being executed, causes a device where the storage medium is located to perform a program installation method, wherein:
the program installation method is executed after installing a driver program corresponding to a peripheral device through a first method;
the first method includes automatically downloading a driver package and automatically installing the driver program in response to a connection signal of the peripheral device; and
the program installation method includes: installing an extension program in the driver package; and creating a shortcut of the extension program in a user interaction interface according to a device information file.

9. The storage medium according to claim 8, wherein: after creating the shortcut of the extension program in the user interaction interface according to the device information file, the program installation method further includes:
creating an uninstallation program corresponding to the shortcut.

10. The storage medium according to claim 8, wherein:
the driver package includes the driver program, the extension program, the device information file, and a dynamic link library file.

11. The storage medium according to claim 10, wherein:
when the uninstallation program corresponding to the driver program and the extension program is executed and the driver program and the extension program are not in use, the driver package, a shortcut and a registry corresponding to the driver program, and the shortcut and registry corresponding to the extension program are deleted.

12. The storage medium according to claim 10, wherein:
creating the shortcut of the extension program in the user interaction interface according to the device information file includes:
running the dynamic link library file based on the device information file; and
creating the shortcut of the extension program in the user interaction interface through a standard interface function of the dynamic link library,
wherein:
the device information file is associated with the dynamic link library file of a registered device corresponding to the extension program; and
the dynamic link library file is associated with the standard interface function; and
the standard interface function is configured to create the shortcut of the extension in the user interaction interface through an application programming interface.

13. The storage medium according to claim 10, wherein, before creating the shortcut of the extension program in the user interaction interface according to the device information file, the program installation method further includes:
adding dynamic link library files and application files corresponding to a status monitor, a network configuration software, or an uninstallation software to the device information file.

14. The storage medium according to claim 8, wherein:
the connection signal includes a universal serial bus connection signal or a local area network connection signal.

15. A computer device, comprising a memory and a processor, wherein:
the memory is configured to store information including program instructions;
the processor is configured to control execution of the program instructions;
when the program instructions are loaded and executed by the processor, the computer device performs a program installation method, wherein:
the program installation method is executed after installing a driver program corresponding to a peripheral device through a first method;
the first method includes automatically downloading a driver package and automatically installing the driver program in response to a connection signal of the peripheral device; and
the program installation method includes: installing an extension program in the driver package; and creating a shortcut of the extension program in a user interaction interface according to a device information file.

16. The computer device according to claim 15, wherein: after creating the shortcut of the extension program in the user interaction interface according to the device information file, the program installation method further includes:
creating an uninstallation program corresponding to the shortcut.

17. The computer device according to claim 15, wherein:
the driver package includes the driver program, the extension program, the device information file, and a dynamic link library file.

18. The computer device according to claim 17, wherein:
when the uninstallation program corresponding to the driver program and the extension program is executed and the driver program and the extension program are not in use, the driver package, a shortcut and a registry corresponding to the driver program, and the shortcut and registry corresponding to the extension program are deleted.

19. The computer device according to claim 17, wherein:
creating the shortcut of the extension program in the user interaction interface according to the device information file includes:
running the dynamic link library file based on the device information file; and
creating the shortcut of the extension program in the user interaction interface through a standard interface function of the dynamic link library,
wherein:
the device information file is associated with the dynamic link library file of a registered device corresponding to the extension program; and
the dynamic link library file is associated with the standard interface function; and
the standard interface function is configured to create the shortcut of the extension in the user interaction interface through an application programming interface.

20. The computer device to claim 17, wherein, before creating the shortcut of the extension program in the user interaction interface according to the device information file, the program installation method further includes:
adding dynamic link library files and application files corresponding to a status monitor, a network configuration software, or an uninstallation software to the device information file.
